(19) United States
(12) Patent Application Publication
(10) Pub. No.: US 2026/0031971 A1
(43) Pub. Date: Jan. 29, 2026

(54) DRIVING ASSISTANCE DEVICE, DECODING DEVICE, ENCRYPTION SYSTEM, ENCRYPTION METHOD AND DECODING METHOD

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Naoki SEKI, Nisshin-shi (JP)

(21) Appl. No.: 19/222,578

(22) Filed: May 29, 2025

(30) Foreign Application Priority Data
Jul. 24, 2024 (JP) 2024-118414

(51) Int. Cl. H04L 9/00; H04L 9/30

(52) U.S. Cl. CPC H04L 9/008; H04L 9/30

(57) ABSTRACT

A driving assistance device mounted on a vehicle includes at least one sensor, an encryption unit, and a communication unit. The at least one sensor obtains detection information items that are categorized into predetermined categories. The encryption unit encrypts the detection information items using public keys each of which corresponds to a respective one of the predetermined categories, creates a table that indicates a correspondence between the encrypted detection information items and the corresponding predetermined categories, creates a table that indicates a correspondence between the encrypted detection information items and the corresponding predetermined categories, and encrypts the created table using a homomorphic encryption. The communication unit transmits the encrypted detection information items and the homomorphically encrypted table.

### CROSS REFERENCE TO RELATED APPLICATION

The present application claims the benefit of priority from Japanese Patent Application No. 2024-118414 filed on Jul. 24, 2024. The entire disclosure of the above application is incorporated herein by reference.

### TECHNICAL FIELD

The present disclosure relates to a driving assistance device, a decoding device, an encryption system, an encryption method, and a decoding method.

### BACKGROUND

There is technique in which information detected by a sensor is transmitted to a data center outside of a vehicle.

### SUMMARY

According to one aspect of the present disclosure, a driving assistance device of a vehicle includes at least one sensor, an encryption unit, and a communication unit. The at least one sensor is configured to obtain detection information items. The encryption unit is configured to encrypt the detection information items using public keys. The public keys may correspond respectively to predetermined categories for the detection information items. The encryption unit may be configured to create a table that indicates a correspondence between the encrypted detection information items with the corresponding predetermined categories, and encrypt the table using a homomorphic encryption. The communication unit may be configured to transmit the encrypted detection information items and the homomorphically encrypted table.

### BRIEF DESCRIPTION OF THE DRAWINGS

FIG. 1 is a schematic diagram showing the configuration of an encryption system.

FIG. 2 is a flowchart showing an example of an encryption process.

FIG. 3 is an explanatory diagram showing one example of a table.

FIG. 4 is a flowchart showing an example of a decoding process.

FIG. 5 is a flowchart showing an example of an encryption process according to a second embodiment.

FIG. 6 is a flowchart showing an example of a decoding process according to the second embodiment.

FIG. 7 is a diagram showing the configuration of an encryption system according to a third embodiment.

### DETAILED DESCRIPTION

To begin with, examples of relevant techniques will be described.

There is technique in which information detected by a sensor is transmitted to a data center outside of a vehicle in an autonomous driving or a driving assistance using Advanced Driving Assistant System (i.e., ADAS) of a vehicle. A driving assistance system encrypts information using various types of private keys to transmit the information.

In recent years, there has been an increasing demand for information items detected by various sensors in a vehicle. Specifically, there is a demand to provide only a part of the information items detected by various sensors when the data center requires only the part of the information items. Furthermore, when there are multiple data centers, it is necessary to provide required information for each data center, which causes complicated processing.

The present disclosure has been made to solve the above problems, and can be implemented as the following embodiments.

According to one aspect of the present disclosure, a driving assistance device mounted on a vehicle is provided. The driving assistance device includes at least one sensor, an encryption unit, and a communication unit. The at least one sensor is configured to obtain detection information items that are categorized into predetermined categories. The encryption unit is configured to encrypt the detection information items using public keys. Each of the public keys corresponds to a respective one of the predetermined categories. The encryption unit is further configured to create a table that indicates a correspondence between the encrypted detection information items with the corresponding predetermined categories, and encrypt the table using a homomorphic encryption. The communication unit is configured to transmit the encrypted detection information items and the homomorphically encrypted table.

According to the driving assistance device of this embodiment, detection information items are encrypted using public keys that correspond to predetermined categories of the detection information items, and the table which indicates a correspondence between the detection information items and the predetermined categories is homomorphically encrypted. Thus, an information item in a specific category can be provided in a decodable manner without requiring a process of decoding all of the detection information items to obtain the information item in the specific category, or a process of transmitting only a part of detection information items in the specific category.

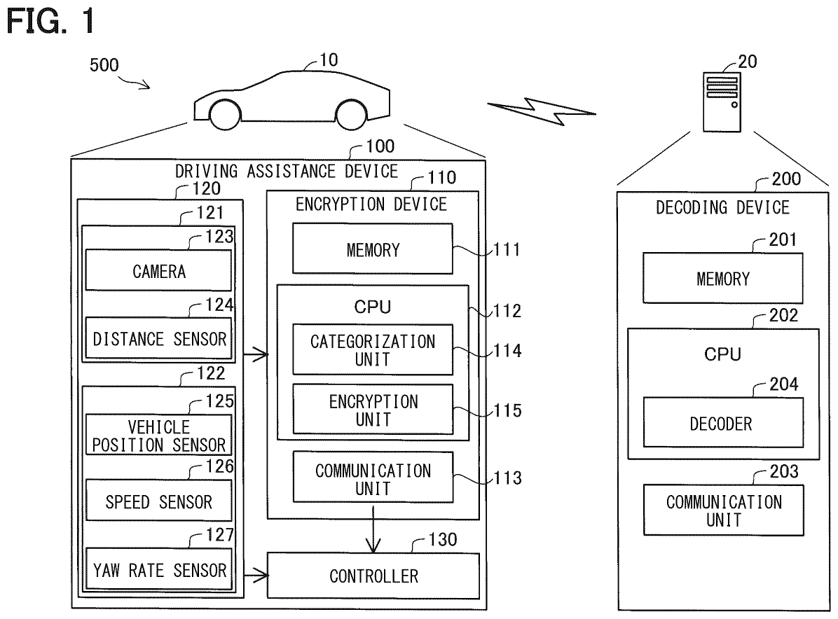

A. First embodiment: As shown in FIG. 1, an encryption system 500 in a first embodiment includes a vehicle 10 equipped with a driving assistance device 100, and a server 20. The driving assistance device 100 has an encryption device 110, and the server 20 has a decoding device 200.

The driving assistance device 100 assists in driving the vehicle 10 to realize an ADAS. The driving assistance device 100 includes the encryption device 110, sensors 120, and a controller 130.

The sensors 120 acquires detection information items. The detection information items include, for example, external information related to the external environment of the vehicle 10 and internal information related to the vehicle 10. The external information may be information regarding targets located around the vehicle 10. The internal information may be information regarding travelling of the vehicle 10 and information regarding a driver of the vehicle 10. In this embodiment, the sensors 120 include external sensors 121 that acquires external information and internal sensors 122 that acquires internal information.

In this embodiment, the external sensors 121 includes a camera 123 and a distance sensor 124. The camera 123 captures the surrounding of the vehicle 10 to obtain an image. The distance sensor 124 measures the distance to objects around the vehicle 10. Examples of the distance sensor 124 include Light Detection and Ranging (LIDAR) and millimeter-wave radar that use reflected waves.

In this embodiment, the internal sensors 122 include a vehicle position sensor 125, a vehicle speed sensor 126, and a yaw rate sensor 127. The vehicle position sensor 125 detects the current coordinate position of the vehicle 10. Examples of the vehicle position sensor 125 include Global Positioning System (i.e., GPS) and Global Navigation Satellite System (i.e., GNSS). The vehicle speed sensor 126 measures the current traveling speed of the vehicle 10. The yaw rate sensor 127 is a detector that detects the yaw rate (i.e., rotational angular velocity) around the vertical axis of the vehicle's center of gravity. Example of the yaw rate sensor 127 includes a gyro sensor.

The encryption device 110 includes a memory 111, a CPU 112, and a communication unit 113. The CPU 112 executes a program pre-installed in the memory 111 to realize the functions of a categorization unit 114 and an encryption unit 115. However, some or all of the functions of these units may be realized by hardware circuits. The encryption device 110 encrypts detection information items that include information on targets detected by the sensors 120 and transmits the information items to the decoding device 200 via the communication unit 113. In addition, the encryption device 110 creates and encrypts a table relating to the encrypted detection information items, and transmits the table to the decoding device 200 via the communication unit 113.

The categorization unit 114 categorizes the detection information items related to the vehicle 10 detected by the sensors 120 into predetermined categories. Examples of the predetermined categories include categories according to types of the sensors 120 that detect the detection information items, and categories according to types of objects recognized from the image captured by the camera 123.

The encryption unit 115 encrypts detection information items related to the vehicle 10 detected by the sensors 120. In addition, the encryption unit 115 creates a table relating to the categories of the encrypted detection information items, and homomorphically encrypts the table. The details of the encryption will be described later. The table may be a table that indicates the correspondence between encrypted detection information items and the corresponding predetermined categories. That is, the table indicates which information corresponds to which category.

The communication unit 113 transmits the information items encrypted by the encryption unit 115 to the decoding device 200.

The controller 130 is a computer formed of a CPU, RAM, and ROM. The CPU of the controller 130 executes a program pre-installed in a storage area such as a RAM or ROM of the controller 130, thereby realizing driving assistance function. More specifically, the controller 130 controls the steering and driving speed of the vehicle 10 by controlling a driving force control device, a braking force control device, and a steering control device (not shown) mounted on the vehicle 10 based on information detected by the sensors 120 and information indicating the categories assigned by the categorization unit 114. However, some or all of the functions of these units may be realized by hardware circuits.

The server 20 is installed in a data center. The decoding device 200 includes a memory 201, a CPU 202, and a communication unit 203. The CPU 202 executes a program pre-installed in the memory 201 to realize the functions of a decoder 204. However, some or all of the functions of these units may be realized by hardware circuits. The decoding device 200 decodes the information items encrypted by the encryption device 110.

The decoder 204 decodes only required information item among the encrypted detection information items, which are encrypted by the encryption device 110 and received through the communication unit 203. The details of decoding will be described later.

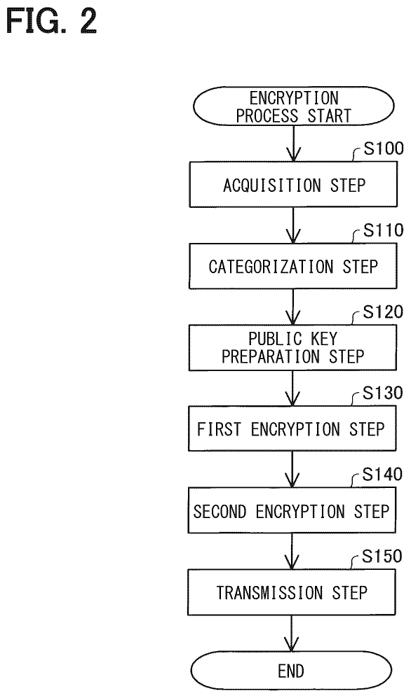

The encryption process shown in FIG. 2 is a process in which the encryption device 110 encrypts the detection information. This process is repeatedly executed by the encryption device 110 while the vehicle 10 is traveling. For example, the process is executed every 100 ms.

In step S100, the encryption unit 115 executes an “acquisition step” to obtain detection information items from the sensors 120.

In step S110, the categorization unit 114 executes a “categorization step” to categorize the detection information items obtained in step S100 into predetermined categories. For example, the categorization unit 114 categorizes the detection information items according to types of objects recognized from the image captured by the camera 123. The categorization unit 114 also categorizes information items acquired by other sensors while the camera 123 was capturing the image of the object, as information related to the category of the object. More specifically, the categorization unit 114 may categorize detection information items into “traffic signal,” “lane marking,” “sign,” and “pedestrian.” The categorization unit 114 also categorizes the distance to the traffic light acquired by the distance sensor 124 and the internal information acquired by the internal sensor 122 while the camera 123 was capturing an image of the “traffic light” into the category of traffic light.

In step S120, the encryption unit 115 executes a “public key preparation step” to prepare a public key for each of the categories. The encryption unit 115 may generate a public key, or may obtain an already generated public key from outside. In this embodiment, the encryption unit 115 selects a public key to be used for encryption of each category from multiple public keys generated in advance and stored in the memory 111. The encryption unit 115 also creates a table that indicates the correspondence between the categories and the selected public keys. Note that steps S100, S110, and S120 are not limited to this order, and may be performed in any order or in parallel, as long as step S110 is performed after step S100.

In step S130, the encryption unit 115 executes a “first encryption step” to encrypt the detection information items acquired in step S100 using the different public keys between the categories prepared in step S120. The first encryption step may be performed with RSA cryptography.

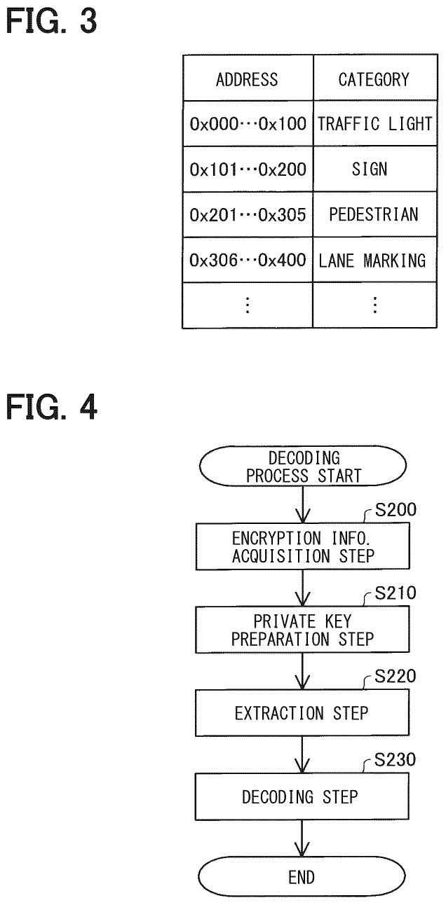

In step S140, the encryption unit 115 executes a “second encryption step” to create a table which indicates the correspondence between the encrypted detection information items encrypted in step S130 and the categories, and to homomorphically encrypt the table. An example of the encryption method having homomorphism is fully homomorphic encryption. The information encrypted in the second encryption step is also called an “encrypted table.” The table that associates the encrypted detection information items with the categories indicates which category each of the encrypted detection information items falls into. That is, the table indicates which category each of the detection information items before encryption falls into. The encryption unit 115 creates a table that indicates the correspondence between the address of each item in the encrypted detection information items and a respective one of the categories, as shown in FIG. 3.

In step S150 (FIG. 2), the encryption device 110 executes a “transmission step” to transmit the encrypted detection information items, which are encrypted in step S130, and the homomorphically encrypted table, which is encrypted in step S140, to the decoding device 200. In this embodiment, the encryption device 110 transmits the table that indicates the correspondence between the categories and the public keys, which is created in step S120, as well as the encrypted detection information items and the homomorphically encrypted table. The encryption device 110 may perform the process of step S150 to transmit the encrypted information items after the process of step S140 has been completed. Alternatively, the encryption device 110 may perform the process of step S150 upon receiving information that the server 20 can receive the encrypted information items.

The decoding process shown in FIG. 4 is a process in which the decoding device 200 decodes the encrypted detection information items, which are encrypted by the encryption device 110. This process may be executed every time information is received from the encryption device 110.

In step S200, the decoder 204 executes an “encrypted detection information acquisition step” to obtain the encrypted detection information items and the homomorphically encrypted table from the encryption device 110. In this embodiment, the decoder 204 receives, from the encryption device 110, the table which indicates the correspondence between the categories and the public keys as well as the encrypted detection information items and the encrypted table.

In step S210, the decoder 204 executes a “private key preparation step” to prepare at least one private key for decoding at least one of the encrypted detection information items, which are encrypted by the encryption device 110 in the first encryption process described above. The private key may be obtained from the encryption device 110 or may be stored in advance in the memory 201. In this embodiment, the decoder 204 selects at least one of the private keys corresponding to the at least one category of information required by the decoding device 200 among the private keys, which are pre-stored in the memory 201. The decoder 204 selects the at least one private key using the table which indicates the correspondence between the public keys and the categories, which is received from the encryption device 110 together with the encrypted detection information items. Each of the private keys is paired with a respective one of the public keys. Steps S200 and S210 are not limited to being performed in this order, and may be performed in any order, or may be performed in parallel.

In step S220, the decoder 204 executes an “extraction process”. In the extraction process, the decoder 204 searches and extracts the required information item, which is a part of the detection information items required by the server 20, from the encrypted detection information items received from the encryption device 110 in step S200, using the encrypted table received from the encryption device 110 in step S200. More specifically, the decoder 204 acquires a part of the encrypted information items which is categorized into the category of the required information item, using the encrypted table and an access right table stored in the memory 201. The decoder 204 extracts the required information item from the encrypted detection information items using the acquired information.

In step S230, the decoder 204 executes a “decoding step” to decode the required information item extracted in step S220 using the private key prepared in step S210. Steps S220 and S230 may be performed in parallel.

The driving assistance device 100 in the first embodiment described above is configured to encrypt detection information items with public keys corresponding to the predetermined categories, respectively. Additionally, the driving assistance device 100 is configured to homomorphically encrypt a table which indicates the correspondence between each item among the detection information items and its respective predetermined category. Thus, an information item in a specific category can be provided in a decodable manner without requiring a process of decoding all of the detection information items to obtain the information in the specific category, or a process of transmitting only the detection information item in the specific category.

Additionally, the driving assistance device 100 homomorphically encrypts, in the second encryption process, the table that indicates the correspondence between the encrypted detection information items and the predetermined categories. Thus, encryption can be performed in a shorter time than compared to the case where all detection information items are homomorphically encrypted.

Furthermore, when the decoding device 200 stores the encrypted detection information items previously received and requires an additional information item in a different category, the decoding device 200 can acquire the additional information item from the previously received encrypted detection information items using a private key corresponding to the required category. Thus, the decoding device 200 can obtain the information item in the required category which is included in the previously obtained detection information items, without the encryption device 110 holding those detection information items.

In this embodiment, the encryption device 110 prepares a table that indicates the correspondence between the predetermined categories and the public keys, and transmits the table to the decoding device 200. Thus, the decoding device 200 can more reliably prepare a private key corresponding to the public key used for encryption.

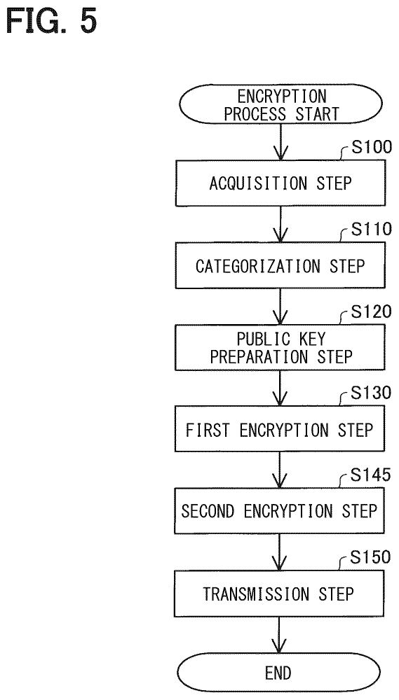

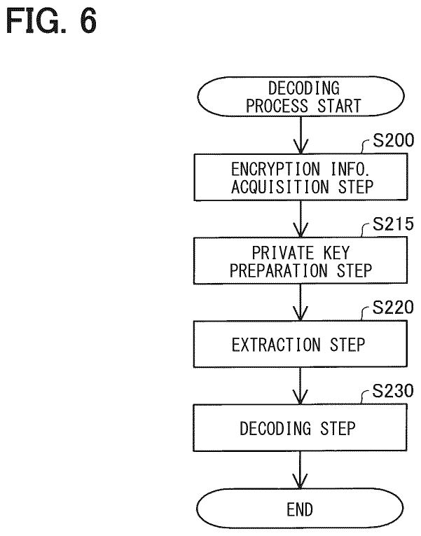

B. Second embodiment: The encryption process in the second embodiment shown in FIG. 5 differs from the encryption process in the first embodiment in that the table indicating that the correspondence between the categories and the public keys is also homomorphically encrypted in step S145. The other steps are the same as those in the first embodiment. Also, the decoding process in the second embodiment shown in FIG. 6 differs from the decoding process in the first embodiment in that a private key is prepared using an encryption table in step S215. The other steps of the decoding process are the same as those in the first embodiment. The configuration of the encryption system 500 of the second embodiment is the same as the configuration of the encryption system 500 of the first embodiment, thus a description of the configuration of the encryption system 500 will be omitted.

In step S145, the encryption unit 115 creates a table that indicates the correspondence between the categories in the table created in step S120 and the encrypted detection information items encrypted in step S130, and homomorphically encrypts the table. That is, the encryption unit 115 creates a table in which the categories, the public keys, and the encrypted detection information are associated with each other, and performs encryption.

In step S215, the decoder 204 uses the encryption table received from the encryption device 110 in step S200 to select a private key corresponding to the required category.

According to the driving assistance device 100 in the second embodiment described above, the encryption device 110 homomorphically encrypts the table that indicates the correspondence between the categories and the public keys, and transmits the homomorphically encrypted table to the decoding device 200. Thus, the process of transmitting, to the decoding device 200, information in which the categories and the public keys are associated with each other that is prepared in advance can be omitted, so that the confidentiality of the correspondence between the categories and the public keys can be improved.

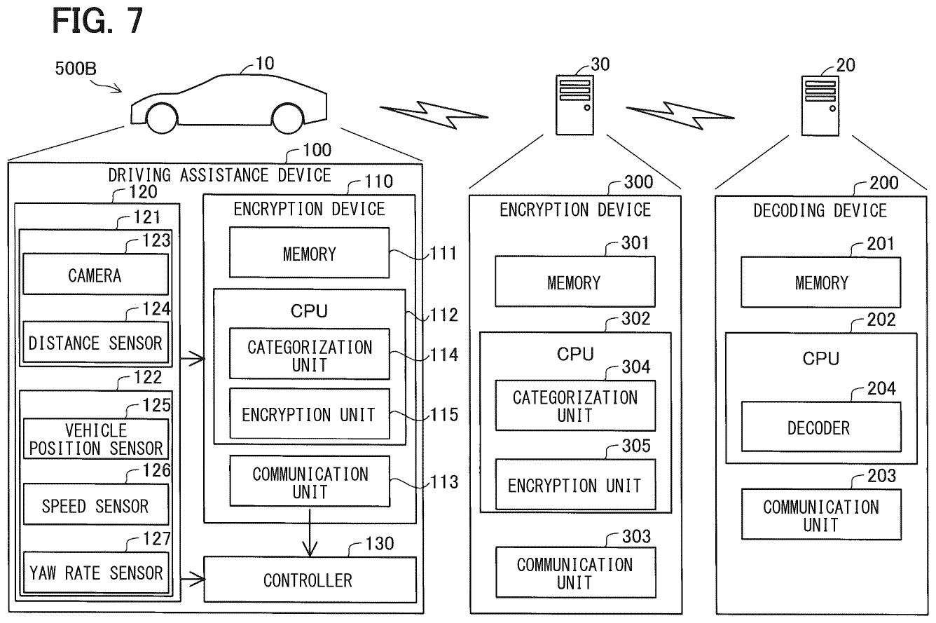

C. Third embodiment: The encryption system 500B of the third embodiment shown in FIG. 7 is different from the first embodiment in that the encryption system 500B includes a server 30 having an encryption device 300 and that the encryption device 110 does not perform encryption processing. The other configurations are the same.

In the third embodiment, the driving assistance device 100 transmits detection information items including information on targets detected by the sensors 120 to the encryption device 300 of the server 30.

The server 30 is installed in a data center. The encryption device 300 in the server 30 has the same configuration as the encryption device 110. The encryption device 300 includes a memory 301, a CPU 302, and a communication unit 303. The CPU 302 executes a program pre-installed in the memory 301 to realize the functions of a categorization unit 304 and an encryption unit 305. However, some or all of the functions of these units may be realized by hardware circuits. The encryption device 300 performs the above-mentioned encryption process on the detection information obtained from the driving assistance device 100 via the communication unit 303, and transmits the encrypted detection information items to the decoding device 200 via the communication unit 303.

According to the encryption system 500B in the third embodiment described above, the encryption device 300 outside the vehicle 10 performs the encryption process, so that the processing load on the driving assistance device 100 can be reduced.

D. Other Embodiments: (D1) In the above-described embodiments, the driving assistance device 100 has multiple sensors including the external sensor 121 and the internal sensor 122. Without being limited thereto, the driving assistance device 100 may be include only the external sensor 121 or only the internal sensor 122. The internal sensor 122 may also include an in-vehicle camera that monitors the driver's condition, or a tactile sensor that detects whether the driver is gripping the steering wheel of the vehicle 10.

(D2) In the above-described embodiments, the encryption device 110 includes the categorization unit 114. The encryption device 110 only needs to include the encryption unit 115 and does not necessarily need to include the categorization unit 114. In this case, the categorization unit 114 is realized by, for example, a microcontroller formed of a CPU, RAM, and ROM, which is different from the encryption device 110 of the driving assistance device 100. In the above-mentioned acquisition step, the encryption device 110 acquires detection information items and information indicating the correspondence between the detection information items and the predetermined categories.

(D3) In the above-described embodiments, the public keys respectively corresponding to the predetermined categories may be different keys using the same algorithm, or may be keys using different algorithms. For example, the key length of the public key for data classified as requiring high confidentiality, such as facial information of the driver of the vehicle 10, may be 2048 bits, and the key length of the public key for data classified as other as 1024 bits.

(D4) In the first and third embodiments described above, the encryption device 110 creates a table that indicates the correspondence between the categories and the public keys, and transmits the table to the decoding device 200. Alternatively, the external server 20 may create the table that indicates the correspondence between the categories and the public keys, and transmit the table to the decoding device 200.

(D5) In the first and second embodiments described above, the driving assistance device 100 includes the encryption device 110. Without being limited thereto, the driving assistance device 100 does not necessarily have to include the encryption device 110. In this case, the encryption device 110 is mounted on the vehicle 10 separately from the driving assistance device 100.

(D6) In the second encryption step in the second embodiment described above (see step S145 in FIG. 5), the encryption unit 115 creates a table that indicates the correspondence among the categories, the encrypted detection information items, and the public keys, and homomorphically encrypts the created table. Alternatively, the encryption unit 115 may separately create a table that indicates the correspondence between the categories and the public keys and a table that indicates the correspondence between the encrypted detection information items and the categories, and encrypt each of the tables.

(D7) In the third embodiment described above, the encryption device 110 included in the vehicle 10 may perform the categorization step and the first encryption step, and the encryption device 300 included in the server 30 may perform the second encryption step. Alternatively, the encryption device 110 may perform the categorization step, and the encryption device 300 may perform the first encryption step and the second encryption step. In this case, the encryption device 300 acquires the detection information items and information indicating the correspondence between the categories and the detection information items.

The present disclosure should not be limited to the embodiments described above, and various other embodiments may be implemented without departing from the scope of the present disclosure. For example, the technical features in the present disclosure may be replaced or combined to solve some or all of the above-described issues, or to provide one of the above-described effects. Also, if the technical features are not described as essential in the present application, they can be deleted as appropriate.

The encryption device 110 and its methods described in this disclosure may be implemented by a dedicated computer provided by configuring a processor and memory programmed to execute one or more functions embodied by a computer program. Alternatively, the controller and its methods described in this disclosure may be implemented by a dedicated computer provided by configuring a processor with one or more dedicated hardware logic circuits. Alternatively, the restriction unit and its methods described in this disclosure may be implemented by one or more dedicated computers configured by a combination of a processor and memory programmed to execute one or more functions and one or more hardware logic circuits. Additionally, the computer program may be stored on a computer-readable non-transitory tangible recording medium as instructions executed by a computer.

1. A driving assistance device configured to be mounted on a vehicle, the driving assistance device comprising:
at least one sensor configured to obtain detection information items that are categorized into a plurality of predetermined categories;
an encryption unit configured to:
encrypt the detection information items using a plurality of public keys, each of the plurality of public keys corresponding to a respective one of the plurality of predetermined categories;
create a table that indicates a correspondence between the encrypted detection information items and the corresponding predetermined categories; and
encrypt the created table using a homomorphic encryption; and
a communication unit configured to transmit the encrypted detection information items and the homomorphically encrypted table.

2. The driving assistance device according to claim 1, wherein
the encryption unit is further configured to create the table that indicates a correspondence between the predetermined categories and the corresponding public keys.

3. A decoding device configured to decode the encrypted detection information items according to claim 1, the decoding device comprising:
a decoder configured to:
select one of a plurality of private keys corresponding to a required item among the detection information items using the table or information indicative of a correspondence between the predetermined categories and the corresponding public keys, each of the plurality of private keys being paired with a respective one of the plurality of public keys; and
decode only the required item of the detection information items using the selected one of the plurality of private keys.

4. An encryption system comprising:
an encryption device configured to encrypt detection information items obtained by at least one sensor mounted on a vehicle, the detection information items being categorized into a plurality of predetermined categories; and
a decoding device configured to decode the encrypted detection information items, wherein
the encryption device is further configured to:
encrypt the detection information items using a plurality of public keys, each of the plurality of public keys corresponding to a respective one of the plurality of predetermined categories;
create a table that indicates a correspondence between the encrypted detection information items with the corresponding predetermined categories;
encrypt the created table using a homomorphic encryption; and
transmit the encrypted detection information items and the homomorphically encrypted table,
the decoding device is configured to:
select one of a plurality of private keys corresponding to a required item among the detection information items using the table or information indicative of a correspondence between the predetermined categories and the corresponding public keys, each of the plurality of private keys being paired with a respective one of the plurality of public keys; and
decode only the required item of the detection information items using the selected one of the plurality of private keys.

5. An encryption method comprising:
obtaining detection information items relating to a vehicle from at least one sensor, the detection information items being categorized into a plurality of predetermined categories;
encrypting the detection information items with a plurality of public keys, each of the plurality of public keys corresponding to a respective one of the plurality of predetermined categories;
creating a table that indicates a correspondence between the encrypted detection information items and the corresponding predetermined categories; and
encrypting the created table using a homomorphic encryption.

6. A decoding method to decode the encrypted detection information items according to claim 5, the decoding method comprising:
selecting one of a plurality of private keys corresponding to a required item among the detection information items using the table or information indicative of a correspondence between the plurality of predetermined categories and the corresponding public keys, each of the plurality of private keys being paired with a respective one of the plurality of public keys; and
decoding only the required item of the detection information items using the selected one of the plurality of private keys.
